(19) United States
(12) Patent Application Publication
(10) Pub. No.: US 2010/0288698 A1
(43) Pub. Date: Nov. 18, 2010

(54) METHOD FOR REMOVING PHOSPHORUS USING MEMBRANE BIOREACTOR

(76) Inventors: Zhimin LIAO, Nanchang (CN); Jianzhong XIONG, Nanchang (CN); Shengyun YANG, Nanchang (CN); Jialin ZHOU, Nanchang (CN); Lingyun HE, Nanchang (CN); Aiguo WAN, Nanchang (CN); Dejin JU, Nanchang (CN); Zhihua YUAN, Nanchang (CN); Jiejun CAO, Nanchang (CN); Kun TAO, Nanchang (CN)

Correspondence Address: MATTHIAS SCHOLL, 14781 MEMORIAL DRIVE, SUITE 1319, HOUSTON, TX, 77079, US

(21) Appl. No.: 12/780,851

(22) Filed: May 14, 2010

(30) Foreign Application Priority Data
May 15, 2009 (CN) 200910115350.1

(51) Int. Cl. C02F 11/02; C02F 11/04

(52) U.S. Cl. 210/630

(57) ABSTRACT

A method for removing phosphorus having steps of a) providing a membrane bioreactor having a membrane module having a lower part; b) aerating intensively the lower part of the membrane module while controlling dissolved oxygen concentration around the membrane module at more than 2 mg/L and dissolved oxygen concentration in the rest zone at less than 1 mg/L so as to form an aerobic zone, a facultative aerobic zone, and an anaerobic zone; and c) introducing sludge having a concentration of between 10,000 mg/L and 30,000 mg/L and having an organic loading of between 0.08 and 0.07 Kg (COD)/(Kg (MLSS)·d) into the membrane reactor so that phosphorus is absorbed in the aerobic zone, released in the facultative aerobic zone, and reduced by phosphine-reducing bacteria into phosphine. The method for removing phosphorus does not include discharging sludge. An apparatus employed for the process does not take up much additional space.

### CROSS-REFERENCE TO RELATED APPLICATIONS

Pursuant to 35 U.S.C. §119 and the Paris Convention Treaty, this application claims the benefit of Chinese Patent Application No. 200910115350.1 filed May 15, 2009, the contents of which are incorporated herein by reference.

### BACKGROUND OF THE INVENTION

1. Field of the Invention

The invention relates to a method for removing phosphorus, and more particularly to a method for removing phosphorus using a membrane bioreactor and without sludge discharge.

2. Description of the Related Art

Conventional methods of phosphorus removal mainly focus on a biochemical process which requires a combination of a facultative aerobic condition and an aerobic condition. Under an aerobic condition, phosphorus-accumulating microorganisms in the sludge absorb phosphorus in a large amount. Subsequently, the sludge flows to an anaerobic zone or a facultative aerobic zone where the absorbed phosphorus is released, and then part of sludge is discharged so as to remove phosphorus from the sewage treatment system. The method for removing phosphorus is based on the sludge discharge from the system, so it has the following disadvantages:
1. To remove phosphorus, a large amount of sludge needs to be discharged, but currently the sludge discharged by municipal wastewater treatment plant can be only about 2% of the total sewage treatment capacity, how to deal with the remaining sludge remains a difficult problem; and
2. The method requires a combination of a facultative aerobic zone and an aerobic zone which are generally distributed separately; therefore, the process is complicated, occupies a large area, and is difficult from the standpoint of maintenance.

### SUMMARY OF THE INVENTION

Accordingly, in view of the above-described problems, it is one objective of the invention to provide a method for removing phosphorus that need not discharge sludge and occupies a small area.

To achieve the above objectives, in accordance with one embodiment of the invention, there is provided a method for removing phosphorus, the method comprising
a) providing a membrane bioreactor comprising a membrane module having a lower part;
b) aerating intensively the lower part of the membrane module while controlling dissolved oxygen concentration around the membrane module at more than 2 mg/L and dissolved oxygen concentration in the rest zone at less than 1 mg/L so as to form an aerobic zone, a facultative aerobic zone, and an anaerobic zone; and
c) introducing sludge having a concentration of between 10,000 mg/L and 30,000 mg/L and having an organic loading of between 0.08 and 0.07 Kg (COD)/(Kg (MLSS)·d) into the membrane bioreactor so that phosphorus is absorbed in the aerobic zone, released in the facultative aerobic zone, and reduced by phosphine-reducing bacteria into phosphine.

In a class of this embodiment, the aerobic zone is about less than one third by volume of the whole reaction zone of the membrane bioreactor, and the rest is the facultative aerobic zone or the anaerobic zone.

In a class of this embodiment, the aeration is in a manner of blower aeration or jet aeration with a gas-water ratio of less than 19:1.

Upon aeration, the sludge flows circularly along the aerobic zone, the facultative aerobic zone, and the anaerobic zone, which provides a biochemical reaction environment of phosphorus absorption at aerobic zone, phosphorus release at facultative aerobic zone, and phosphorus removal by gasification process at anaerobic zone. The proliferation and self-digestion of the sludge can maintain in a dynamic equilibrium, so no sludge needs to be discharged.

In a class of this embodiment, phosphine-reducing bacteria in the sludge are filtered by a membrane material having a pore size of between 0.01 and 10 μm and retain in the membrane bioreactor.

In embodiment of the invention, inorganic phosphorus is firstly transformed into organic phosphorus by microorganisms for cell synthesis. The organic phosphorus is reduced by phosphine-reducing bacteria and transformed into phosphine in the anaerobic zone. The phosphine is treated by an aeration system.

Advantages of the invention are summarized as below. In embodiment of the invention, the aeration intensity is concentrated on the lower part of the membrane module, so an aerobic zone is formed, which provides a biochemical reaction condition for phosphorus absorption and cell synthesis. Subsequently, the sludge flows to the upper part of the membrane module where dissolved oxygen is little and phosphorus is released. By the filtration of the membrane module, the phosphine-reducing bacteria are accumulated and multiply in the bioreactor, which prompts the phosphorus removal of gasification process and no sludge discharged.

### BRIEF DESCRIPTION OF THE DRAWINGS

The invention is described hereinbelow with reference to accompanying drawings, in which:

FIG. 1 is a schematic diagram of phosphorus removal by gasification process in a membrane bioreactor according to one embodiment of the invention.

### DETAILED DESCRIPTION OF THE EMBODIMENTS

For further illustrating the invention, experiments detailing a method for removing phosphorus that need not discharge sludge and occupies a small area are described below. It should be noted that the following examples are intended to describe and not to limit the invention.

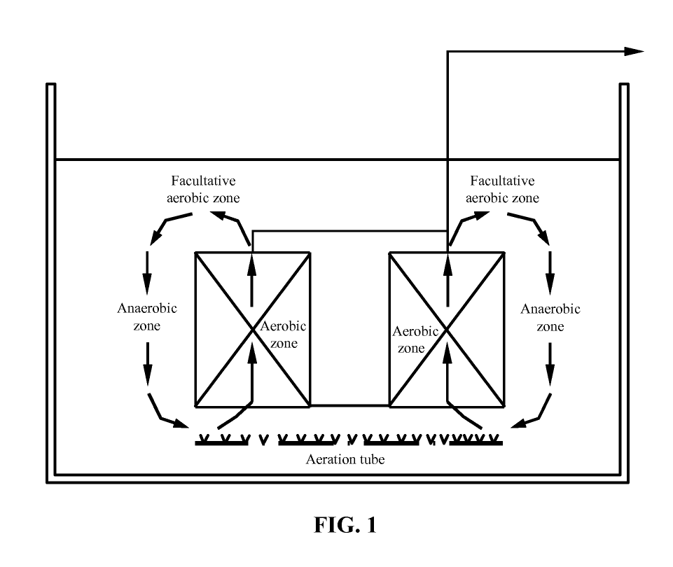

In a membrane bioreactor comprising a membrane module having a lower part, the lower part of the membrane module is aerated intensively, and the dissolved oxygen concentration around the membrane module is more than 2 mg/L and the dissolved oxygen concentration in the rest zone less than 1 mg/L. Thus, an aerobic, zone, a facultative aerobic zone, and an anaerobic zone are formed respectively (as shown in FIG. 1), which provides a biochemical reaction environment of phosphorus absorption at the aerobic zone and phosphorus release at the anaerobic zone. Since the dissolved oxygen is utilized quickly by the aerobic microorganisms, the upper part of the membrane module is a facultative aerobic zone or even an anaerobic zone. When the sludge flows to the upper part of the membrane module, phosphorus is released. Sludge having a concentration of between 10,000 mg/L and 30,000 mg/L and having an organic loading of between 0.08 and 0.07 Kg (COD)/(Kg (MLSS)·d) is introduced into the membrane reactor so as to accelerate the digestion of the sludge and maintain a dynamic equilibrium of the proliferation and self-digestion of the sludge. When microorganisms decompose due to endogenous respiration, the degradation of amino acid produces phospholipids having C—P bond. When phosphine-reducing bacteria process the phospholipids, C—P bond breaks up, and phosphine is produced.

Using filtration at the membrane module, phosphine-reducing bacteria are accumulated and multiply in the bioreactor, which provides conditions for phosphorus removal of gasification. The following is the process of the biochemical reaction:

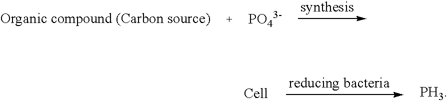

Thus, the invention provides a novel method for removing phosphorus by gasification process, no need to discharge sludge.

EXAMPLE 1

In a sewage treatment plant, the daily sewage treatment is 80 m³/d. The membrane bioreactor is facultative aerobic, and the treatment process adopts the method of the invention, involving in no sludge discharge. The TP concentration of the sewage is monitored, and the effect of phosphorus removal is as follows.

The mean value of total phosphorus of influent is 2.82 mg/L, and that of effluent is 0.84 mg/L, the mean value of phosphorus removal is 1.98 mg/L. The total phosphorus content in the sludge is between 1.22% and 1.69%, with mean value of 1.49%. This is equivalent to phosphorus removal by a conventional biochemical process, and phosphorus is not accumulated in the sludge. Although no sludge discharged, the total phosphorus loss reaches 70%. Monitoring the gas at the top of the treatment system shows the phosphine content is between 1 and 3 ppm, which is much higher than that in the air (0 ppm). Thus, without sludge discharge, the phosphorus is successfully removed using a gasification process.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. A method for removing phosphorus comprising
a) providing a membrane bioreactor comprising a membrane module having a lower part;
b) aerating intensively said lower part of said membrane module while controlling dissolved oxygen concentration around said membrane module at more than 2 mg/L and dissolved oxygen concentration in the rest zone less than 1 mg/L so as to form an aerobic zone, a facultative aerobic zone, and an anaerobic zone; and
c) introducing sludge having a concentration of between 10,000 mg/L and 30,000 mg/L and having an organic loading of between 0.08 and 0.07 Kg (COD)/(Kg (MLSS)·d) into said membrane bioreactor so that phosphorus is absorbed in said aerobic zone, released in said facultative aerobic zone, and reduced by phosphine-reducing bacteria into phosphine.

2. The method of claim 1, wherein said aerobic zone is less than one third by volume of the whole reaction zone of said membrane bioreactor, and the rest is the facultative aerobic zone or the anaerobic zone.

3. The method of claim 1, wherein said aeration is in a manner of blower aeration or jet aeration with a gas-water ratio of less than 19:1.

4. The method of claim 1, wherein said phosphine-reducing bacteria in the sludge are filtered by a membrane material having a pore size of between 0.01 and 10 μm and retain in said membrane bioreactor.
